(19) United States
(12) Patent Application Publication
(10) Pub. No.: US 2004/0257193 A1
(43) Pub. Date: Dec. 23, 2004

(54) Resistive material

(75) Inventors: Craig S. Allen, Shrewsbury, MA (US); Andrew T. Hunt, Atlanta, GA (US); Wen-Yi Lin, Chu Tung Town (TW); David D. Senk, Mission Viejo, CA (US); John Schemenaur, Marlborough, MA (US)

Correspondence Address: EDWARDS & ANGELL, LLP, P.O. BOX 55874, BOSTON, MA, 02205, US

(73) Assignee: Shipley Company, L.L.C., Marlborough, MA

(21) Appl. No.: 10/688,458

(22) Filed: Oct. 17, 2003

Related U.S. Application Data
(60) Provisional application No. 60/419,637, filed on Oct. 18, 2002.

(51) Int. Cl. H01C 1/012

(52) U.S. Cl. 338/308

(57) ABSTRACT

Resistive materials have resistivities that are axis dependent are provided. Such resistive materials having a resistivity in a first direction and a very different resistivity in an orthogonal direction. These resistive materials are particularly suitable for use as resistors embedded in printed wiring boards.

### BACKGROUND OF THE INVENTION

The present invention relates generally to the field of resistive materials. In particular, the present invention relates to the field of resistive materials suitable for use as embedded resistors in electronic devices.

Printed circuit boards typically include large numbers of electronic devices which are commonly surface mounted and also additional components which may be present in the form of active layers within each printed circuit board. The requirements for the devices and components in such printed circuit boards are subject to conventional electronic design restraints. In particular, many of the surface mounted devices and other components on such printed circuit boards commonly require coupling with individual resistors in order to achieve their desired function.

The most common solution to this problem in the prior art has been the use of individual resistors as additional surface mounted components on the printed circuit boards. Design of the printed circuit boards has further required the provision of through-holes in order to properly interconnect the resistors. In this regard, the resistors may be interconnected between any combination of surface devices or components or active components or layers formed on or within the printed circuit boards.

As a result, the complexity of the printed circuit boards has increased and at the same time the available surface area of the printed circuit boards for other devices has decreased or else the overall size of the printed circuit boards has increased to accommodate necessary surface devices and components including resistors.

One solution to this has been the use of planar resistors preferably formed on internal layers of the printed circuit boards in order to replace surface mounted resistors as described above while making surface portions of the printed circuit boards free for other uses. For example, U.S. Pat. No. 4,808,967 (Rice et al.) discloses a printed wiring board having a support layer, a layer of electrical resistance material adhering to the support layer, and a conductive layer adhering to the electrical resistance layer.

A problem with certain conventional planar resistors is that the resistivity measured in a first direction may differ slightly from the resistivity measured in a second direction orthogonal to the first direction. If care is not taken in the manufacture of an electronic device, such as a printed wiring board, such planar resistors may be used in the wrong orientation. In such cases, the actual resistivity of may differ from that desired, thus adversely affecting the performance of the printed wiring board.

One of the objections to adopting embedded resistor technology in printed wiring board manufacture is that such resistor technology is limited in the range of values that it can provide. Unless large serpentine patterns are employed, a single layer of embedded resistor material is limited to about three decades of values, such as, for example, from 50 ohms to 5,000 ohms. In order to accommodate values above this range one must place discrete resistors on the surface of the printed wiring board, which negates some of the gain from embedding the resistor within the board, or alternatively, use a second sheet of higher resistivity material, which carries a higher cost of materials penalty.

There has been significant effort to make the resistivity in all directions of a resistor uniform in industry with uncontrolled variations being significantly less than 50%. What is truly needed in the art is resistive material having a defined and controlled variation in resistivity of 100% or more depending on the axis chosen.

### SUMMARY OF THE INVENTION

It has been surprisingly found that the sheet resistivity of a material may be significantly changed by structuring such material. Such structured resistivity material has very different sheet resistivities in orthogonal directions, thus increasing the likelihood of the correct orientation of the resistive material during electrode formation to form a resistor.

The present invention provides a method of manufacturing a resistive material device including the steps of: a) providing a substrate having a structured surface; and b) disposing a layer of a resistive material on the structured surface of the substrate.

In one embodiment, the present invention provides a method of manufacturing a resistive material device including the steps of: a) providing a substrate having a structured surface; b) disposing a layer of resistive material on the structured surface of the substrate; c) disposing a layer of conductive material on the resistive material layer; and d) separating the substrate from the resistive material layer to provide a resistive material device.

In another embodiment, the present invention provides a method of manufacturing a resistive material device including the steps of: a) providing a conductive material layer having a structured surface; and b) disposing a layer of resistive material on the structured surface of the conductive material layer.

A resistive material device including a conductive material layer and a layer of resistive material disposed on the conductive material layer wherein the resistive material layer is structured is provided by the present invention. Preferably, the resistive material layer has a first resistivity along a first axis, and a second resistivity along a second axis, the first resistivity being at least twice the value of the second resistivity.

The present invention also provides a resistor including a layer of resistive material and a pair of conductive pads disposed at opposite ends of the resistive material layer, wherein the resistive material layer is structured.

Electronic devices including one or more resistors described above are also provided by this invention.

### BRIEF DESCRIPTION OF THE DRAWING

FIG. 1 illustrates a cross-sectional view of a resistive material device including a structured resistive material layer, not to scale.

FIGS. 2A-D illustrate isometric views of structured resistive material layers, not to scale.

FIGS. 3A-3D illustrate a method of manufacturing an electronic device including an embedded resistor, not to scale.

FIGS. 4A-4D illustrate an alternative method of manufacturing an electronic device including an embedded resistor, not to scale.

### DETAILED DESCRIPTION OF THE INVENTION

As used throughout this specification, the following abbreviations shall have the following meanings, unless the context clearly indicates otherwise: ° C.=degrees centigrade; nm=nanometer; μm=micron=micrometer; Å=angstrom; Ω=Ohms; Ω/□=Ohms per square; M=molar; wt %=percent by weight; and mil=0.001 inch.

The terms “printed wiring board” and “printed circuit board” are used interchangeably throughout this specification. By “substantially orthogonal” it is meant directions that are substantially at right angles to each other, i.e. 90°±15°, preferably 90°±10°, more preferably 90°±5° and still more preferably 90°±3°. Unless otherwise noted, all amounts are percent by weight and all ratios are by weight. All numerical ranges are inclusive and combinable in any order, except where it is clear that such numerical ranges are constrained to add up to 100%.

The present invention provides a resistive material device including a resistive material layer disposed on a substrate, wherein the resistive material layer is structured. A wide variety of resistive materials are suitable for use in this invention. Suitable resistive materials include, but are not limited to, a mixture of a conductive material and a minor amount of a highly resistive (dielectric) material. A very small amount of the highly resistive material, e.g., about 0.1 wt % to about 20 wt %, very profoundly reduces the conductive properties of the conducting material. Although noble metals are conductors, it is found that in depositing noble metals along with relatively minor amounts of oxides, such as silica or alumina, the deposited material becomes highly resistive. Accordingly, metals, such as platinum, containing minor amounts, e.g., 0.1% to 5% of an oxide, can serve as resistors in printed circuit boards. For example, platinum, though an excellent conductor, when co-deposited with between 0.1 and about 5 wt % silica, serves as a resistor, the resistivity being a function of the level of silica co-deposited. Any conductive material is suitable, such as, but not limited to, platinum, iridium, ruthenium, nickel, copper, silver, gold, indium, tin, iron, molybdenum, cobalt, lead, palladium, and the like. Suitable dielectrics include, but are not limited to, metal oxides or metalloid oxides, such as silica, alumina, chromia, titania, ceria, zinc oxide, zirconia, phosphorous oxide, bismuth oxide, oxides of rare earth metals in general, phosphorus, and mixtures thereof.

Preferred electrically resistive materials for use as the first material are nickel-based or platinum-based, i.e., the major material is nickel or platinum, respectively. Suitable preferred resistive materials are nickel-phosphorus, nickel-chromium, nickel-phosphorus-tungsten, ceramics, conductive polymers, conductive inks, platinum-based materials such as platinum-iridium, platinum-ruthenium and platinum-iridium-ruthenium. Preferred platinum-based materials contain from about 10 to 70 mole percent iridium, ruthenium or mixtures thereof, and preferably 2 mole percent to 50 mole percent, calculated relative to platinum being 100 percent. If ruthenium is used alone (without iridium), it is preferably used at between about 2 and about 10 mole percent calculated relative to platinum being 100 percent. If iridium is used alone (without ruthenium), it is preferably used at between about 20 and about 70 mole percent calculated relative to platinum being 100 percent. In the resistive materials in accordance with the invention, the iridium, ruthenium or mixtures thereof exist in both elemental form and in oxide form. Typically, the iridium, ruthenium or mixtures thereof are from about 50 to about 90 mole percent elemental metal and from about 10 to about 50 mole percent oxide(s) of the iridium, ruthenium or mixtures thereof.

The thickness of the resistive material layer may vary over a wide range. Preferably, the resistive material has a thickness of up to 2 mil (0.05 mm) and more preferably up to 1 mil (0.025 mm). For use in embedded resistors, the resistive material is typically at least about 40 Å thick. In general, the thickness of the resistive material layer is from 40 to 100,000 Å (10 microns), preferably from 40 to 50,000 Å, and more preferably from 100 to 20,000 Å. While the first resistive material layer may be self-supporting, it is typically too thin to be self-supporting and must be deposited on a substrate which is self-supporting.

Resistive material layers having a structured surface are typically obtained by despositing the resistive material on a surface of a substrate where the substrate surface is structured. The surface of the resistive material layer adjacent to the structured substrate surface typically conforms to the structured surface of the substrate during deposition. In this way, a layer of resistive material having a structured surface is obtained on a structured surface of a substrate and a conductive material layer is then disposed on the surface of the resistive material layer opposite to the structured surface. In such a device, the structured surface of the resistive material layer is not adjacent to the surface of the conductive layer.

For example, resistive materials may be disposed on a surface of a conductive material substrate, such as a metal foil, having structures. Other suitable conductive materials are well known to those skilled in the art, such as conductive metal oxides, conductive polymers and the like. Suitable metal foils include, but are not limited to, copper foil, nickel foil, silver foil, gold foil, platinum foil, aluminum foil and alloys of the foregoing. Conductive metal foils suitable for use in the present invention may have a wide range of thicknesses. Typically, such conductive metal foils have nominal thicknesses ranging from 0.0002 to 0.02 inches (0.005 to 0.5 mm). Metal foil thicknesses are often expressed in terms of weights. For example, suitable copper foils have weights of from 0.125 to 14 ounces per square foot, more preferably 0.25 to 6 ounces per square foot, and still more preferably from 0.5 to 5 ounces per square foot. Particularly suitable copper foils are those having weights of 3 to 5 ounces per square foot, while more common copper foils have weights of 1 to 3 ounces per square foot. Suitable conductive metal foils may be prepared using conventional electrodeposition techniques and are available from a variety of sources, such as Oak-Mitsui or Gould Electronics.

The conductive material substrates may further include a barrier layer. Such barrier layer may be on the first side of the conductive material, i.e. the side nearest the resistive material, the second side of the conductive layer or on both sides of the conductive layer. Barrier layers are well known to those skilled in the art. Suitable barrier layers include, but are not limited to, zinc, indium, tin, nickel, cobalt, chromium, brass, and bronze. Such barrier layers may be deposited by a variety of means including, without limitation electrolytically, electrolessly, by immersion plating, by sputtering, by chemical vapor deposition, combustion chemical vapor deposition (“CCVD”), controlled atmosphere chemical vapor deposition (“CACCVD”), and mixtures thereof. Preferably, such barrier layers are deposited electrolytically, electrolessly or by immersion plating. In one embodiment, when the conductive layer is a copper foil, it is preferred that a barrier layer is used.

Following the application of a protective barrier layer, a protective layer of chromium oxide may be chemically deposited on the barrier layer or the conductive material. Finally, a silane may be applied to the surface of the conductive material/barrier layer/optional chromium oxide layer in order to further improve adhesion. Suitable silanes are those disclosed in U.S. Pat. No. 5,885,436 (Ameen et al.).

The resistive materials may be deposited on the substrate by a variety of means, such as sol-gel deposition, sputtering, chemical vapor deposition, combustion chemical vapor deposition, controlled atmosphere combustion chemical vapor deposition, spin coating, roller coating, silk screening, electroplating, electroless plating and the like. For example, nickel-phosphorus resistive materials may be deposited by electroplating. See, for example, International Patent Application No. WO 89/02212. In one embodiment, it is preferred that the resistive material is deposited by CCVD and/or CACCVD. The deposition of resistive materials by CCVD and/or CACCVD is well known to those skilled in the art. See, for example, U.S. Pat. No. 6,208,234 (Hunt et al.) for a description of such processes and apparatuses used.

CCVD has the advantages of being able to deposit very thin, uniform layers which may serve as the dielectric layers of embedded capacitors and resistors. The material can be deposited to any desired thickness; however, for forming resistive material layers by CCVD, thicknesses seldom exceed 50,000 Å (5 microns). Generally film thicknesses are in the 100 to 10,000 Å range, most generally in the 300 to 5000 Å range. Because the thinner the layer, the higher the resistivity and the less material, e.g., platinum, used the ability to deposit very thin films is an advantageous feature of the CCVD process. The thinness of the coating also facilitates rapid etching in processes by which discrete resistors are formed.

For resistive material which is a mixture of a conductive metal and a minor amount of a dielectric material, the metal must be capable of being deposited as a zero valence metal from an oxygen-containing system if the resistive material is to be deposited by CCVD or CACCVD. The criteria for deposition in the zero valence state using a flame is that the metal must have a lower oxidation potential than the lower of the oxidation potential of carbon dioxide or water at the deposition temperature. (At room temperatures, water has a lower oxidation potential; at other temperatures carbon dioxide has a lower oxidation potential.) Zero valence metals which can be readily deposited by CCVD are those having oxidation potentials about equal to silver or below. Thus, silver, gold, platinum and iridium can be deposited by straight CCVD. Zero valence metals having somewhat higher oxidation potentials may be deposited by CACCVD which provides a more reducing atmosphere. Nickel, copper, indium, palladium, tin, iron, molybdenum, cobalt, and lead are best deposited by CACCVD. Herein, metals also include alloys that are mixtures of such zero-valence metals. Silicon, aluminum, chromium, titanium, cerium, zinc, zirconium, magnesium, bismuth, rare earth metals, and phosphorous each have relatively high oxidation potentials, such that if any of the metals mentioned above are codeposited with the appropriate precursors for the dielectric dopants, the metals will deposit in the zero valence state and the dopant will deposit as the oxide. Thus, even when no flame is used the dielectric needs to have a higher oxidation, phospidation, carbidation, nitrodation, or boridation potential, to form the desired two phases.

For more oxygen-reactive metals and alloys of metals, CACCVD may be the process of choice. Even if the metal can be deposited as a zero valence metal by straight CCVD, it may be desirable to provide a controlled atmosphere, i.e., CACCVD, if the substrate material on which it is to be deposited is subject to oxidation. For example, copper and nickel substrates are readily oxidized, and it may be desired to deposit onto these substrates by CACCVD.

Another type of resistive material which can be deposited as a thin layer on a substrate by CCVD is “conductive oxides”. In particular, Bi₂Ru₂O₇ and SrRuO₃ are conductive oxides which may be deposited by CCVD. Although these materials are “conductive”, their conductivity is relatively low when deposited in amorphous state; thus, a thin layer of such mixed oxides can be used to form discrete resistors. Like conductive metals, such “conductive oxides” may be doped with dielectric materials, such as metal or metalloid oxides, to increase their resistivity. Such mixed oxides may be deposited either as amorphous layers or as crystalline layers, amorphous layers tending to deposit at low deposition temperatures and crystalline layers tending to deposit at higher deposition temperatures. For use as resistors, amorphous layers are generally preferred, having higher resistivity than crystalline materials. Thus, while these materials are classified as “conductive oxides” in their normal crystalline state, the amorphous oxides, even in un-doped form, may produce good resistivity. In some cases it may be desired to form low resistance, 1 to 100 Ω, resistors and a conduction-enhancing dopant, such as platinum, gold, silver, copper or iron, may be added. If doped with dielectric material, e.g., metal or metalloid oxides, to increase resistivity of the conducting oxides, or conduction-enhancing material to decrease resistivity of the conducting oxides, such homogeneously mixed dielectric or conduction-enhancing material is generally at levels between 0.1 wt % and 20 wt % of the resistive material, preferably at least 0.5 wt %.

There are a variety of other “conducting materials” which, though electrically conducting, have sufficient resistivity to form resistors in accordance with the present invention. Examples include yttrium barium copper oxides and La₁₋ₓSrₓCoO₃, 0≦x≦1, e.g., x=0.5. Generally, any mixed oxide which has superconducting properties below a critical temperature can serve as electrically resistive material above such critical temperature. Deposition of such a variety of resistive materials is possible with proper selection of precursors selected from those described herein above.

To produce a metal/oxide resistive material film using a CCVD or CACCVD process, a precursor solution is provided which contains both the precursor for the metal and the precursor for the metal or metalloid oxide. For example, to produce platinum/silica films, the deposition solution contains a platinum precursor, such as platinum(II)-acetylacetonate or diphenyl-(1,5-cyclooctadiene)platinum (II) [Pt(COD)] and a silicon-containing precursor, such as tetraethoxysilane. Suitable precursors for iridium and ruthenium include, but are not limited to, tris(norbornadiene)iridium (III) acetyl acetonate (“IrNBD”), and bis(ethylcyclopentadienyl)ruthenium (II). The precursors are mixed generally according to the ratio of metal and enhancing material to decrease the resistivity of the material being deposited, an additional precursor is provided so as to produce minor amounts of the metal oxide or metalloid oxide, e.g., between 0.1 and 20 wt %, preferably at least 0.5 wt %, of the deposited doped conducting metal oxide. The precursors typically are co-dissolved in a single solvent system, such as toluene or toluene/propane to a concentration (total of platinum, iridium, and/or ruthenium precursors) of from 0.15 wt % to 1.5 wt %. This solution is then typically passed through an atomizer to disperse the precursor solution into a fine aerosol and the aerosol is ignited in the presence of an oxidizer, particularly oxygen, to produce the platinum and iridium, ruthenium or mixture thereof zero valence metals(s) and oxide(s). See, e.g. U.S. Pat. No. 6,208,234 B1 (Hunt et al.) for a more complete description of the CCVD process.

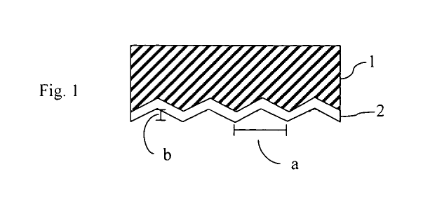

The structured resistive materials of the present invention typically contain a plurality of structures. As used herein, “structured” refers to a resistive material having a three-dimensional, i.e. non-planar, shape. Exemplary structures are, without limitation corrugations and undulations. The peak-to-peak distance of the structured resistive materials may vary considerably. In general, the peak-to-peak distance may range from 0.1 to 5,000 microns, preferably from 0.5 to 1000 microns, and more preferably 1 to 200 microns. FIG. 1 illustrates a resistive material device of the present invention having a conductive layer 1 and a corrugated resistive material 2, having a peak-to-peak distance of (a) for the ridges of the corrugations, and having a peak-to-peak valley distance of (b). The peak-to-valley distance may also vary over a wide range. The greater the peak-to-valley distance, the greater the resistivity between peaks in the direction orthogonal to such structures.

The corrugations may be of any shape, and of various lengths, and may be continuous or discontinuous. If they are discontinuous, then it is desired to have them at least 3 times longer than the peak to valley separation. The higher the aspect ratio of the features (height of the peaks divided by the peak to peak separation) then the larger the directional differential. Aspect ratios can be any value but with many vapor processes 0.5 is desired, with over 1 being preferred and greater than 2 being preferred for greater resistivity variation with direction.

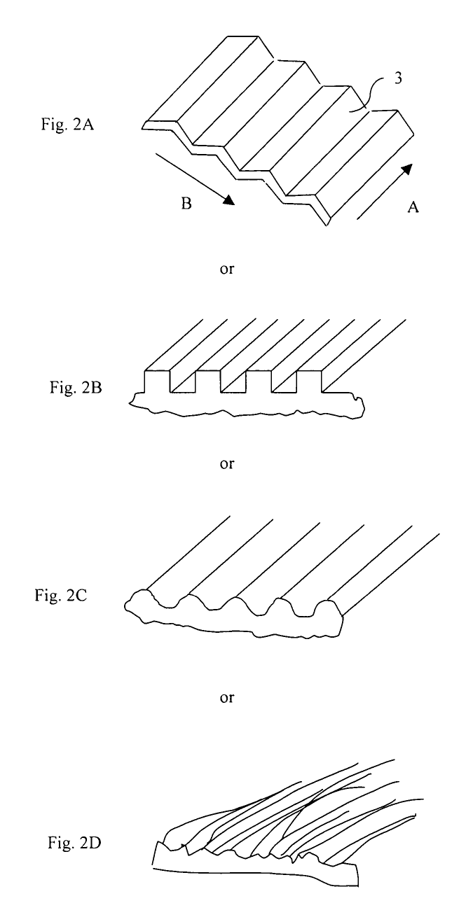

The resistivity of the present structured resistive materials is axis dependent. The structuring of the resistive materials provides a first resistivity in a first direction (e.g. the X-direction) and a second resistivity in a second direction (e.g. Y-direction) that is substantially at right angles to the first direction. Preferably, the resistivity in a first direction is at least 2 times, and more preferably at least 10 times, the resistivity in a second direction that is substantially orthogonal to the first direction. For some applications it is further desired that the resistivity in the first direction is one hundred or even one thousand times the resistivity in the second direction. FIG. 2A illustrates a corrugated resistive material 3 having a first resistivity in a first direction A and a second resistivity in a second direction B that is orthogonal to the first direction. The resistivity of material 3 is higher in direction B than in direction A. Such directional resistivities are achieved by structuring the resistive material 3. FIG. 2B illustrates a resistive material layer having structures that are rectangular in cross section. FIG. 2C illustrates a resistive material layer having structures that are sinusoidal in cross section. FIG. 2D illustrates a resistive material layer having structures that are elongate and discontinuous. Accordingly, the present invention also provides a resistive material device having a conductive layer and a structured resistive material layer wherein the resistive material layer has a first resistivity in a first direction and a second resistivity in a second direction, the second direction being substantially orthogonal to the first direction.

The present structured resistive materials are suitable for the manufacture of resistors, and in particular thin film, embeddable resistors useful in printed wiring board manufacture. Thin film resistors typically have a total thickness of structured resistive material of 4 μm or less, preferably 2 μm or less, more preferably 1 μm or less and even more preferably 0.5 μm or less.

Resistors typically include a pair of electrodes disposed at opposite ends of a resistive material. Such electrodes may be provided in a variety of ways, such as by formation directly on the resistive material or directly formed from an underlying conductive substrate. By way of example, areas of the resistive material to receive the electrode may be catalyzed so that electrodes are deposited, formed, or adhered only to those catalyzed areas. Alternatively, areas that are not to receive the electrode may be masked off, such as by a resist, and the electrode deposited formed or adhered to the unmasked areas.

Suitable electrodes may be formed by any conductive material such as a conductive polymer or a metal. Exemplary metals include, but are not limited to, copper, gold, silver, nickel, tin, platinum, lead, aluminum and mixtures and alloys thereof. “Mixtures” of such metals include non-alloyed metal mixtures and two or more layers of individual metals as in a multilayer electrode. An example of a multilayer electrode is copper having a layer of silver or a layer of nickel on the copper followed by a layer of gold. Such electrodes are typically formed by deposition of a conductive material. Suitable deposition methods include, but are not limited to, electroless plating, electrolytic plating, chemical vapor deposition, CCVD, CACCVD, screen printing, ink jet printing, roller coating and the like. When a conductive paste is used to form the electrode, it is suitably applied by screen printing, ink jet printing, roller coating and the like.

As described above, when the structured resistive material is not self-supporting, it is typically applied to or formed on a substrate. Conductive substrates are particularly suitable for subsequent formation of resistors, particularly thin film resistors, as the conductive substrates can be used to form the pair of electrodes. This is generally accomplished using a photoresist which is used to form a resist pattern over the layer of resistive material and using an appropriate etchant to remove the resistive material in areas not covered by the resist. For metal/oxide resistive material layers, the etchant chosen is an etchant for the metal component of the resistive material. Typically such etchants are acids or Lewis acids, e.g., FeCl₃ or CuCl₂ for copper. Nitric acid and other inorganic acids (e.g., sulfuric, hydrochloric, and phosphoric) may be used to etch nickel, a variety of other metals which may be deposited as well as conductive oxides.

Noble metals, by their non-reactive nature, are difficult to etch. Aqua regia is a suitable etchant for metals, particularly noble metals and is made from two well-know acids: 3 parts concentrated (12M) hydrochloric acid (HCl) and 1 part concentrated (16M) nitric acid HNO₃. Thus, the molar ratio of hydrochloric acid to nitric acid is 9:4, although slight variations from this ratio, i.e., 6:4 to 12:4 would be acceptable for etching purposes in accordance with the invention. Because of its corrosive nature and limited shelf life, aqua regia is not sold commercially, but must be prepared prior to use. To reduce its corrosiveness, the aqua regia may be diluted with water up to about a 3:1 ratio of water to aqua regia. On the other hand, the noble metals, such as platinum, are not etched by many of the materials suitable for etching copper, such as FeCl₃ or CuCl₂, thereby allowing for a variety of selective etching options in forming the present resistors. The speed of etching will depend upon several factors including the strength of the aqua regia and the temperature. Typically, aqua regia etching is conducted at a temperature of 55 to 60° C., although this may be varied depending upon the application.

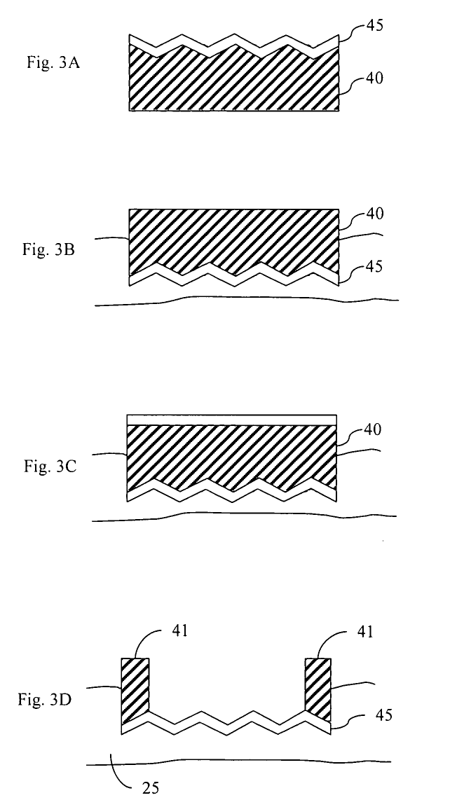

Referring to FIGS. 3A-3E by way of example, the circuitization process begins with a conductive foil 40, such as a copper foil, having a structured surface to which a layer of a electrically resistive material 45 has been deposited, such as by electroplating, CCVD or CACCVD. To form a resistive material device. The resistive material device is then embedded in a laminate dielectric 25, such as glass-reinforced epoxy prepreg, so that conductive foil 40 is exposed at the surface and resistive material 45 is embedded in laminate dielectric 25, as shown in FIG. 3B. Next, photoresist 30 is applied to conductive foil 40 as shown in FIG. 3C, and the photoresist is exposed to pattered actinic radiation. The photoresist is developed and the conductive foil is then selectively etched from areas where the photoresist has been removed. Subsequently, the remaining photoresist is stripped to provide the resistor shown in FIG. 3D having a pair of electrodes 41 disposed at opposite ends of corrugated resistive material 45 embedded in laminate dielectric 25. The resistor shown in FIG. 3D may be used in the assembly of printed circuit boards, particularly in the manufacture of multilayer printed circuit boards.

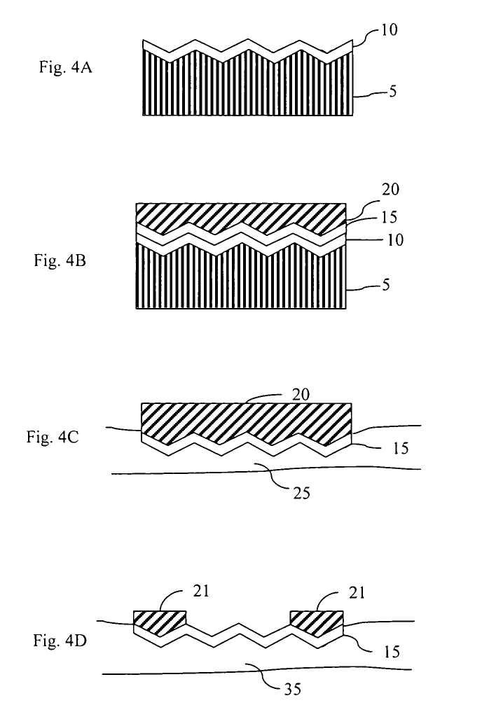

An alternate embodiment is illustrated in FIGS. 4A-4D. Referring to FIG. 4A, a substrate 5 having a structured surface and a compound release layer 10 is provided. The release layer is optional, but aids in subsequent processing. When used, such release layer is conformal, i.e. the release layer maintains the structure surface of the substrate. A resistive material layer 15 is deposited on the release layer 10 and a conductive layer 20 is then deposited on the resistive material layer 15, as shown in FIG. 4B. In these figures, the resistive material layer is shown to be conformal, which is preferred for smaller variations in resistivity with direction. For larger variations in resistivity with direction, it is desired to have larger thickness changes between the peak and trough. One skilled in the art of coatings is aware of processes that will preferentially deposit in the trough and others that preferentially deposit on the ridges. Resistive material layer 15 and conductive layer 20 are then separated from the substrate and embedded in a laminate dielectric 5 as shown in FIG. 4C. A photoresist is then applied to the conductive layer and patterned, the conductive layer is etched and the remaining photoresist is stripped to provide the embedded resistor shown in FIG. 4D having a pair of electrodes 21 disposed at opposite ends of resistive material 15 embedded in laminate dielectric 35.

In the above method, any suitable substrate having a structured surface may be used. Exemplary substrates include, but are not limited to, metals such as copper, silver, nickel, aluminum, brass, tin and steel, ceramics and plastics. Suitable release layers are composed of metal oxides, polymers, oils and mixtures thereof. It will be appreciated by those skilled in the art that other release agents may be used to form the release layers provided that such materials are poorly adherent to the substrate, the resistive material, or both. The release agents must have sufficient adherence to remain in place during processing but be sufficiently poorly adherent to allow for separation of the resistive material layer, such as by peeling. In the above method, the resistive material may be deposited by any suitable means, such as, without limitation, by sol-gel techniques, electroless plating, electroplating, CVD, PVD, CCVD, CACCVD or any combination thereof.

Suitable structured conductive materials and substrates may be prepared by a variety of means, such as, but not limited to, photoimaging and etching, laser, ablation, mechanical processes such as sanding, routing and bending, and molding or forming. In one embodiment, a conductive foil, particularly a copper foil, having a structured surface is used. Such structured copper foil may be formed using conventional electroplating techniques but using a drum having a structured surface.

Typically, copper foils are typically produced by the electrodeposition of copper from an electroplating solution onto a rotating drum, and removed from the drum to provide a continuous copper foil. Any material suitable for use in an electroplating drum may be used. Typically, the drum is composed of a conductive material, such as a conductive metal. Such drum surfaces can be structured by a variety of the means discussed above, but preferably by photoimaging. In this process, the drum is coated with a photoresist, which may be either a liquid or dry film photoresist. The photoresist is then imaged through a mask to provide the desired pattern and then developed. The drum surface is then etched to provide a plurality of the desired structures, and then the remaining photoresist is removed. Such structures may be circumferential or longitudinal, i.e. disposed axially along the periphery of the drum. Preferably, such structures are circumferential as this provides a foil having a continuous structure along its length. The structures on the drum are selected such that are capably of providing a structured metal foil.

A wide variety of laminate dielectrics may be used to embed the present resistive materials and devices. Typically, such laminate dielectrics are organic dielectric materials including, without limitation, polyimide or epoxy (either of which may optionally be glass-filled). The laminate dielectric protects the resistive material layer from further processing and subsequently supports patches of the resistive material layer when portions of the conductive foil is subsequently removed from the other side of the resistive material layer.

When referring herein to “etching”, the term is used to denote not only the common usage in this art where a strong chemical dissolves or otherwise removes the material of one of the layers, e.g., nitric acid dissolves nickel, but also physical removal, such as laser removal and removal by lack of adhesion. In this regard, and in accordance with an aspect of this invention, it is found that resistive materials, such as doped nickel and doped platinum, deposited by CCVD or CACCVD are porous. The pores are believed to be small, typically of a diameter of a micron or less, preferably of a diameter of 50 nanometers or less (1000 nm=1 μm). Nevertheless, this permits liquid etchants to diffuse through the electrically resistive material layer and, in a physical process, destroy the adhesion between the resistive material layer and the underlying layer. For example, if the conductive foil layer is copper and the resistive material layer is doped platinum, e.g., platinum/silica, or doped nickel, e.g., Ni/PO₄, cupric chloride could be used to remove exposed portions of the resistive material layer. The cupric chloride does not dissolve either platinum or nickel, but the porosity of the resistive material layer allows the cupric chloride to reach the underlying copper. A small portion of the copper dissolves and the exposed portions of the electrically resistive layer by physical ablation. This physical ablation occurs before the cupric chloride etches the underlying copper layer to any significant extent.

If copper is the conductive material layer, it is sometimes advantageous to use copper foil that has been oxidized, which is commercially available. An advantage of an oxidized copper foil is that a dilute hydrochloric acid (“HCl”) solution, e.g., ½%, dissolves copper oxide without dissolving zero valence copper. Thus, if the electrically resistive material layer is porous, such that the dilute HCl solution diffuses therethrough, HCl can be used for ablative etching. Dissolving the surface copper oxide destroys the adhesion between the copper foil and the electrically resistive material layer.

The present invention provides a three-layer structure which comprises an insulating substrate, a layer of structured resistive material and conductive patches (i.e. electrodes), e.g., copper disposed at opposite ends of the structured resistive material. Preferably, the insulating substrate is an organic laminate dielectric.

In one embodiment, a resistive material device sheet composed of a structured resistive material on a conductive material sheet is embedded in an organic laminate dielectric to form a three-layer structure.

The three-layer structure might be patterned in one of two two-step procedures by photoimaging technology. In one procedure, the conductive material layer would be covered with a resist, the resist patterned by photoimaging techniques, and, in the exposed areas of the resist, both the conductive material layer and the underlying resistive material layer be etched away, e.g., with aqua regia, to give a structure of having a patterned resistive material device patch. Next, a second photoresist would be applied, photoimaged, and developed. This time, only the exposed portions of the conductive material would be etched away from the resistive material device by an etchant which would selectively etch the conductive layer, but not the structured resistive material, i.e., FeCl₃ or CuCl₂ in the case of copper as the conductive material layer and platinum/silica as the electrically resistive material. In an alternate procedure, a patterned resist layer would be formed, exposed portions of the conductive material layer etched away, e.g., with FeCl₃, a further patterned resist layer formed, and then the exposed areas of the structured resistive material layer etched away with aqua regia so as to form the electrical contacts. By either procedure, discrete thin layer resistors are formed by conventional photoimaging techniques common to printed circuitry formation.

While the present resistors could be at the surface of a printed circuit board device, the resistors will, in most cases, be embedded within a multi-layer printed circuit board, for example where the resistor, which was formed on an organic dielectric substrate, such as polyimide or epoxy, is embedded within additional embedding insulating material layers, such as epoxy/fiberglass prepreg material.

As with standard embedded material, the final value of the resistor is determined by the aspect ratio of the resistor multiplied by the sheet resistivity of the material. Typically, the present resistors have a resistivity in a first direction of 1 to 100,000 Ω, preferably 10 to 100,000 Ω, more preferably 25 to 100,000 Ω, and still more preferably 100 to 100,000 Ω. The resistivity in a second direction that is substantially orthogonal to the first direction is generally greater than the resistivity measured in the first direction. Typically, the present resistor material has a resistivity in a first direction that is ≧2 times the resistivity measured in an orthogonal direction. Preferably, the resistivity in the first direction is ≧5 times the resistivity in the second direction, more preferably ≧10 times and still more preferably ≧20 times yet more preferably ≧50 times, and particularly ≧100 times. For example, the sheet resistivity could be 100 ohms per square in the x-axis and 10,000 ohms per square in the y-axis, yielding resistors of 100 ohms or 10,000 ohms, respectively, depending on the axis of orientation.

Resistors containing the present structured resistive materials may be used in the manufacture of electronic devices, and particularly as resistors embedded in a dielectric material. Thus, the present invention provides an electronic device including a resistor having a structured resistive material having a first resistivity in a first direction and a second resistivity in a second direction, wherein the second direction is substantially orthogonal to the first direction and wherein the first resistivity is greater than or equal to 2 times the second resistivity.

Additional ways of forming larger variations in resistivity with direction is to vary coating thickness and/or material composition between the peaks and troughs. A variation in thickness of greater than 50% is desired to achieve large variations in directional resistivity, while variations of 100% and even 500% are more preferred to even further increase the variation in directionally dependent resistivity. To achieve these variations in thickness, a process can be used that preferentially coats the high areas (peaks), such as atmospheric pressure vapor deposition. To preferentially coat in low areas (troughs) a settling process like sol-gel is used. These processes have a thin coating either peak or trough that increases the resistivity across the structures versus along the structures. If two different materials are formed, one preferentially on the peaks and the other preferentially in the troughs, a larger variation in directional resistivity can be obtained, while still controlling overall material performance and integrity.

In particular, the present resistors are suitable for embedding in a dielectric material in the manufacture of printed wiring boards. Therefore, the present invention also provides an electronic device including a printed wiring board including a resistor having a structured resistive material having a first resistivity in a first direction and a second resistivity in a second direction, wherein the second direction is substantially orthogonal to the first direction and wherein the first resistivity is greater than or equal to 2 times the second resistivity. Also provided by the present invention is an electronic device including a resistor, the resistor including a pair of electrodes and a structured resistive material having a first resistivity in a first direction and a second resistivity in a second direction, wherein the second direction is substantially orthogonal to the first direction.

The present invention provides a method of changing the resistivity of a resistive material layer comprising the step of structuring the resistive material layer in the direction of or orthogonal to the direction of resistivity.

What is claimed is:

1. A method of manufacturing a structured resistive material device comprising the steps of: a) providing a substrate having a structured surface; b) disposing a layer of resistive material on the structured surface of the substrate; c) disposing a layer of conductive material on the resistive material layer; and d) separating the substrate from the resistive material layer to provide a structured resistive material to provide a resistive material device.

2. The method of claim 1 further comprising the step of providing a release layer disposed between the structured surface of the substrate and the resistive material layer.

3. The method of claim 1 wherein the structured surface is substantially corrugated.

4. The method claim 1 wherein the layer of resistive material is deposited on the surface of the substrate such that the resistive material layer is varied in thickness with the structures to form elongate structures.

5. A method of manufacturing a structured resistive material device comprising the steps of: a) providing a conductive material layer having a structured surface; and b) disposing a layer of resistive material on the structured surface of the conductive material layer.

6. The method of claim 5 wherein the structured surface is a substantially corrugated surface.

7. The method of claim 5 wherein the layer of resistive material is deposited on the surface of the substrate such that the resistive material layer is varied in thickness with the structures to form elongate structures.

8. The method of claim 7, wherein the resistive material layer has peaks at the top of the elongate structures and troughs between the elongate structures, and the step of depositing a layer of resistive material further comprises depositing a first resistive material preferentially on the peaks, and a second resistive material preferentially in the troughs.

9. A resistive material device comprising a conductive material layer and a layer of resistive material disposed on the conductive layer wherein the resistive material layer is structured, wherein the resistive material layer has a first resistivity along a first axis, and a second resistivity along a second axis, the first resistivity being at least twice the value of the second resistivity.

10. The resistive material device of claim 9 wherein the resistive material layer is variable in thickness.

11. The resistive material device of claim 9 wherein the first resistivity is at least ten times the value of the second resistivity.

12. The resistive material device of claim 9 wherein the structured resistive material layer is substantially corrugated.

13. The resistive material device of claim 9 wherein structures of the structured resistive material layer are chosen from substantially rectangular in cross-section structures, substantially sinusoidal in cross-section structures, and substantially elongate discontinuous structures.

14. The resistive material device of claim 9 wherein structures of said structured resistive material layer are elongate and have a height to peak to peak ratio of greater than 0.5.

15. The resistive material device of claim 9 wherein the conductive layer forms a pair of conductive pads disposed at opposite ends of the resistive material layer, wherein the resistive material layer is structured.

16. An electronic device comprising one or more resistive material devices of claim 9.

17. A method of manufacturing a structured metal foil comprising the steps of electrodepositing a metal foil on a drum, the drum having a plurality of structures; and removing the metal foil from the drum, the metal foil having structures.

18. The method of claim 16 wherein the structures are disposed circumferentially or longitudinally on the drum.

19. A method of providing a structured drum suitable for forming a structured metal foil comprising the steps of disposing a photoresist on the surface of the drum, exposing the photoresist through a mask, developing the photoresist, etching the drum, and removing the remaining photoresist.
